(19) United States
(12) Patent Application Publication
(10) Pub. No.: US 2016/0039443 A1
(43) Pub. Date: Feb. 11, 2016

(54) WALKING CONVEYANCE CART

(71) Applicant: Sasaki Corporation, Aomori (JP)

(72) Inventors: Toshiyuki Murakami, Aomori (JP); Shigeharu Katchi, Aomori (JP); Tsutomu Toda, Aomori (JP)

(21) Appl. No.: 14/819,991

(22) Filed: Aug. 6, 2015

(30) Foreign Application Priority Data
Aug. 6, 2014 (JP) 2014-160349
Sep. 8, 2014 (JP) 2014-182207

(51) Int. Cl. B62B 5/00; B62B 1/10

(52) U.S. Cl. CPC B62B 5/005; B62B 1/10

(57) ABSTRACT

A conveyance cart having a drive source such as an engine or an electric motor has a complicated structure and is expensive. Using such a conveyance cart exclusively for carrying a generator is not economical. To solve the problem, a simple-structured, low-priced conveyance cart is provided. A walking conveyance cart has an electrically driven traveling part and a placement part for placing thereon a portable engine generator. The electric traveling part can be driven by the power outputted from the portable engine generator placed on the placement part.

### CROSS-REFERENCE TO RELATED APPLICATION(S)

This application is based upon and claims the benefit of priority from Japanese Patent Applications JP2014-160349 filed on Aug. 6, 2014, and JP2014-182207 filed on Sep. 8, 2014, the entire disclosure of which are incorporated herein by reference.

### BACKGROUND

The present invention relates to a conveyance cart provided with an electrically driven traveling part.

Portable engine generators are in general use as simple power supplies which can be used outdoors where appropriate power supplies are not available. They are used in wide ranging applications, for example, at construction sites, on farm land, or for leisure activities. Portable engine generators are, however, relatively heavy. Hence, carrying a portable engine generator by human power to a site of use is a great burden on the persons to carry it. Particularly, in an area where such transportation means as vehicles cannot be used, it is not easy to carry a portable engine generator over a long distance.

Hence, hand carts like the one described in Japanese Examined Utility Model Application Publication No. Sho-50 (1975)-14119 or self-driven conveyance carts are used to carry portable engine generators. However, carrying a portable engine generator using a non-powered hand cart through an outdoor route possibly including slopes is not always easy. Using a self-driven conveyance cart is, therefore, advantageous. The self-driven conveyance carts that have been publicly known include, for example: the one-wheeled hand conveyance cart provided with a motor disclosed in Japanese Examined Utility Model Application Publication No. Sho-51 (1976)-25250; the electric conveyance cart disclosed in Japanese Unexamined Patent Publication No. 2000-6815; the electric conveyance cart disclosed in Japanese Unexamined Patent Publication No. 2000-261912; and the cart mounted with a rechargeable battery disclosed in Japanese Examined Utility Model Application Publication No. Sho-50 (1975)-14119.

The one-wheeled hand conveyance cart provided with a motor disclosed in Japanese Examined Utility Model Application Publication No. Sho-51 (1976)-25250 is provided with a fixing plate 15 (reference number used in the publication; the same applies to the following reference numbers concerning the same conveyance cart) rotatably supported thereon. The fixing plate 15 is for having a motor 25 fixed thereto. A drive roller 21 to be driven by the motor 25 is also attached to the fixing plate 15. The drive roller 21 drives a wheel 3 by being pressed against the wheel 3.

The electric conveyance cart disclosed in Japanese Unexamined Patent Publication No. 2000-6815 includes an electric motor and batteries which are used to drive a front wheel axle mounted with two front wheels and which are provided downward of a cart frame, two rear wheels removably attached to a rear portion of the cart frame, and a one-wheel caster unit which can be attached to the cart instead of the two rear wheels.

The electric conveyance cart disclosed in Japanese Unexamined Patent Publication No. 2000-261912 includes a forward travel operation member and a backward travel operation member. The forward travel operation member and the backward travel operation member are attached to an end portion of an operation handle extending rearwardly and upwardly from a cart frame which is provided with a wheel and a motor to drive the wheel. The forward travel operation member is used to make the motor generate auxiliary power for a forward travel. The backward travel operation member is used to make the motor generate power for a backward travel.

### SUMMARY

A conveyance cart having a drive source such as an engine or an electric motor has a complicated structure and is expensive. Using such a conveyance cart exclusively for carrying a generator is not economical. An object of the present invention is to provide a simple-structured, low-priced conveyance cart.

In order to solve the above-described problem, the present invention provides a walking conveyance cart comprising an electrically driven traveling part, and the walking conveyance cart is characterized in that it includes a placement part for placing thereon a portable engine generator and the traveling part can be driven using power outputted from the portable engine generator placed on the placement part as a power source.

Further, in one embodiment of the walking conveyance cart of the present invention, the placement part is provided on an open plane over the walking conveyance cart.

Further, in another embodiment of the walking conveyance cart of the present invention, the placement part is provided on a cart frame included in the walking conveyance cart.

Furthermore, in another embodiment of the walking conveyance cart of the present invention, the placement part for placing thereon a portable engine generator is configured to allow the portable engine generator to be fixed thereto and removed therefrom, and the traveling part is configured to be releasable from electric drive force to make the walking conveyance cart usable as a non-powered hand conveyance cart.

In addition, in another embodiment of the walking conveyance cart of the present invention, it comprises an auxiliary basket provided adjacent to the placement part.

The walking conveyance cart of the present invention has an electric traveling part which can be driven by the power outputted from a portable engine generator carried by the cart. This makes it unnecessary for the walking conveyance cart itself to be provided with a driving power source. Hence, the present invention can provide a simple-structured, low-priced conveyance cart.

A placement part can be provided on an open plane over the walking conveyance cart, so that a portable engine generator can be easily placed on and removed from the placement part.

The placement part can be provided on a cart frame included in the walking conveyance cart, so that a portable engine generator can be easily placed on and removed from the placement part.

The electric traveling part can be released from electric drive force and, when the electric traveling part is released from electric drive force, the walking conveyance cart can be used as a non-powered hand conveyance cart. This makes it possible to use the walking conveyance cart in diversified ways. Thus, a highly convenient walking conveyance cart which can be used effectively can be provided.

An auxiliary basket is provided adjacent to the placement part, so that objects other than a portable engine generator can also be carried by the walking conveyance cart.

### BRIEF DESCRIPTION OF THE DRAWINGS

FIG. 1 is a side view of a walking conveyance cart in a state with a portable engine generator placed thereon according to a first embodiment representing an example of the present invention.

FIG. 2 is a plan view of the walking conveyance cart in a state with a portable engine generator placed thereon according to the first embodiment representing an example of the present invention.

FIG. 3 is a sectional view taken along line A-A in FIG. 1 of an electric traveling part according to the first embodiment representing an example of the present invention.

FIG. 4 is a sectional view taken along line A-A in FIG. 1 of the electric traveling part in a state released from electric drive force according to the first embodiment representing an example of the present invention.

FIG. 5 is an electrical wiring diagram according to the first embodiment representing an example of the present invention.

FIG. 6 is a perspective view of a walking conveyance cart in a state with a portable engine generator placed thereon according to a second embodiment representing an example of the present invention.

FIG. 7 is a perspective view of the walking conveyance cart in a state with a portable engine generator and other materials placed thereon according to the second embodiment representing an example of the present invention.

### DETAILED DESCRIPTION

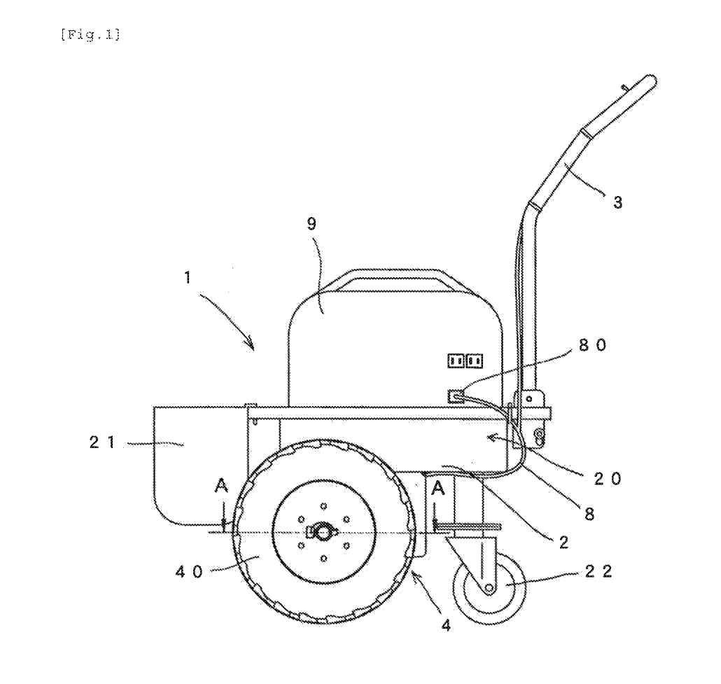

A walking conveyance cart 1 (hereinafter also referred to simply as the “cart 1”) according to a first embodiment of the present invention will be described below with reference to FIGS. 1 to 5. FIG. 1 shows a side view of the cart 1 of the first embodiment. The following description is based on the assumption that the left side of the cart 1 is forward direction of traveling, but the right side of the cart 1 is backward direction of traveling as seen in FIG. 1.

The cart 1 has tires 40, i.e. drive wheels, positioned on each side of a forward portion of a cart frame 2 along the direction of travel of the cart 1. The cart 1 also has caster wheels 22 positioned on each side of a rearward portion of the cart frame 2 with a horizontally swiveling shaft provided vertically and shifted from the wheel axis position of the cart 1. The caster wheels 22 on both sides of the cart frame 2 may be replaced by a single caster wheel provided around the center in the rearward portion of the cart frame 2 or may be replaced by a downwardly projecting stand-like support frame.

A placement part 20 shaped like an open box capable of carrying a portable engine generator 9 is provided over the cart frame 2 to be between the tires 40 positioned on both sides of the forward portion of the cart frame 2 and to be above the caster wheels 22. An auxiliary basket 21 which can accommodate, for example, electric cords or a fuel container containing fuel for the portable engine generator 9 is provided forward of the placement part 20. Positioning the placement part 20 such that its bottom part is upward of the tires 40 allows the placement part 20 to be made wider without causing interference between itself and the tires 40.

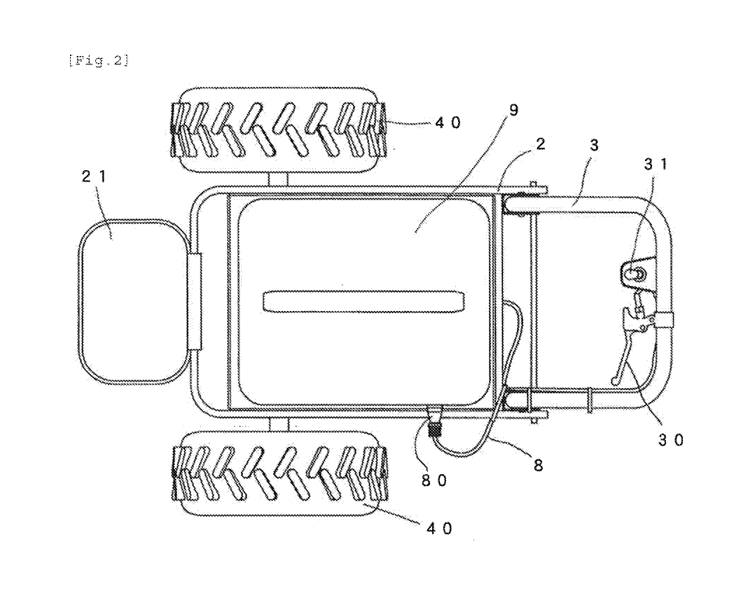

On the rear side of the cart frame 2, a handle 3 is provided to extend upwardly and rearwardly from left and right rear end portions of the placement part 20 of the cart frame 2, so that, as seen from above, the handle 3 is U-shaped with the open side of the U shape facing forward as shown in FIG. 2. The handle 3 is provided, in an upper central portion thereof, with a forward/backward changeover switch lever 31 and a travel switch lever 30 both for use by the user. When the forward/backward changeover switch lever 31 is pushed forward into a forward travel position, the cart 1 can travel forward. When the forward/backward changeover switch lever 31 is pulled backward into a backward travel position, the cart 1 can travel backward. When the travel switch lever 30 and the handle 3 are grasped together bringing the travel switch lever 30 closer to the handle 3, the cart 1 starts traveling forward or backward. The base portions fixed to the cart frame 2 of the handle 3 are forwardly foldable, so that the cart 1 can be compactly stored when not in use.

A power cord 8 for supplying power to an electric traveling part 4 extends from a lower portion of the cart frame 2. The power cord 8 is, at an end portion thereof, provided with a power plug 80 which can be plugged into a power outlet of the portable engine generator 9 placed on the placement part 20.

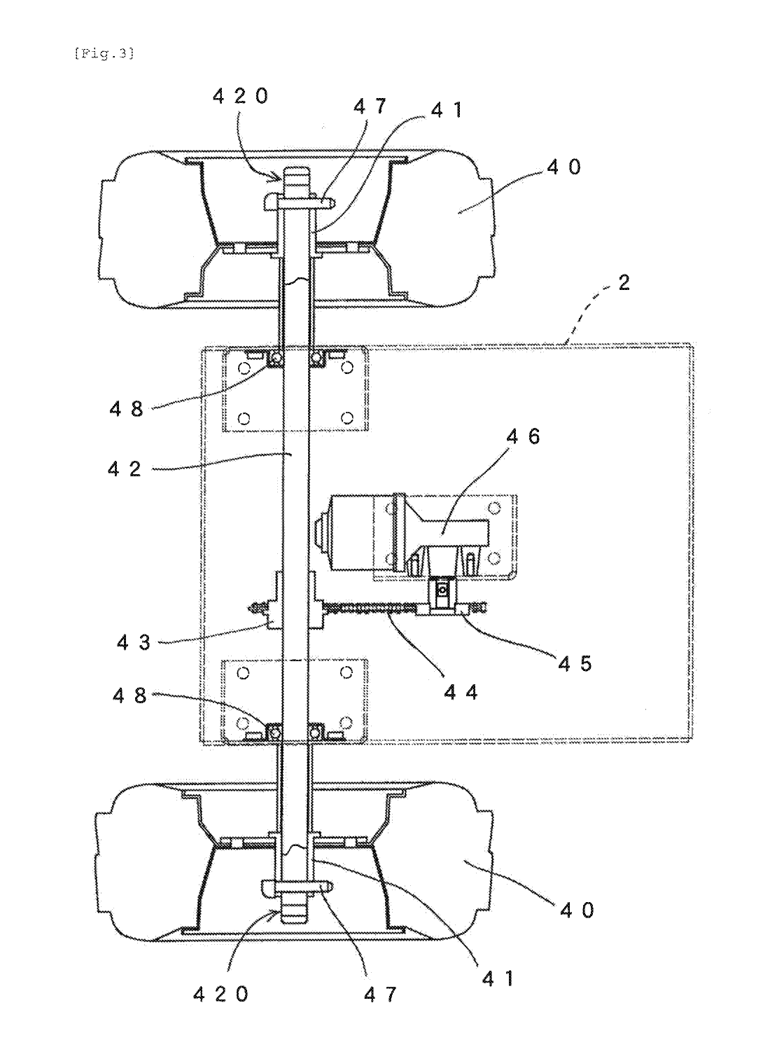

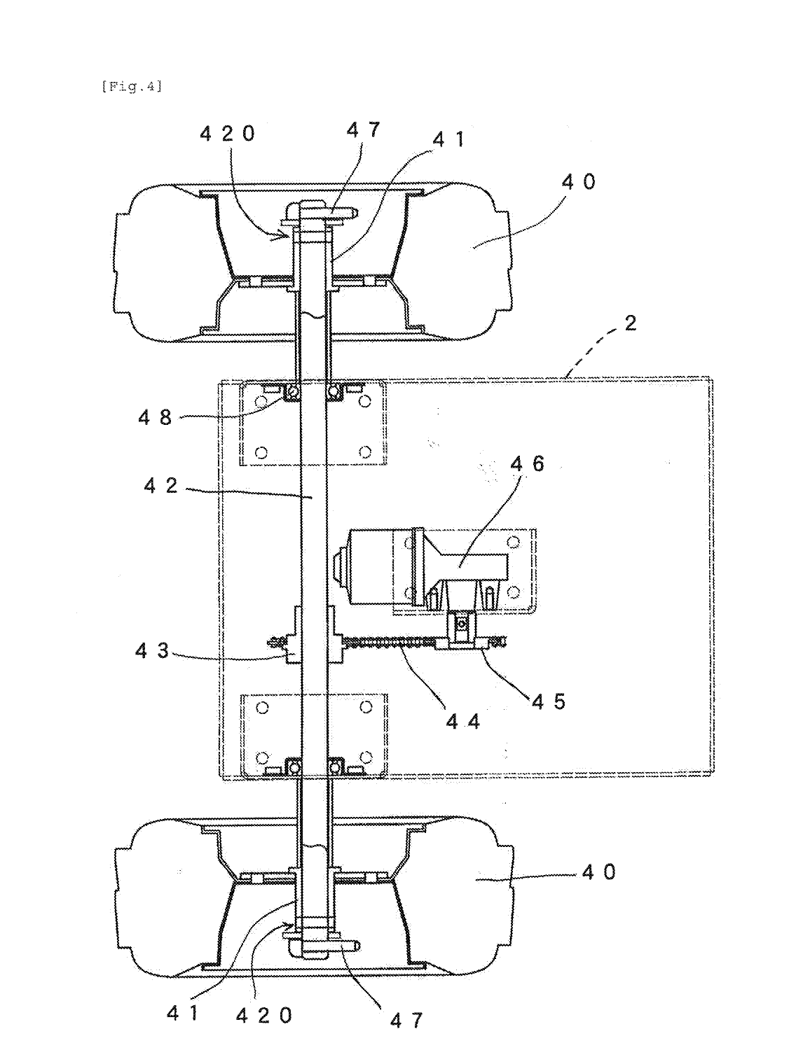

FIGS. 3 and 4 are each a sectional view taken along line A-A in FIG. 1 and each show a main portion of the electric traveling part 4. An axle 42 is provided to extend horizontally in a direction perpendicular to the travel direction of the cart 1. The axle 42 is rotatably supported, at left and right end portions of the cart frame 2, by bearings 48. The axle 42 is mounted, at left and right end portions thereof, with tires 40 to be drive wheels via tire bosses 41, respectively.

An electric motor 46 for driving the tires 40 is attached to a central portion of the underside of the cart frame 2. The electric motor 46 has an output shaft which extends perpendicularly to the travel direction of the cart 1 and is fixedly provided with a motor sprocket 45. A roller chain 44 is wound over the motor sprocket 45 and an axle sprocket 43 fixed to the axle 42. In this configuration, when the electric motor 46 rotates, the axle 42 rotates to drive the tires 40.

Each tire 40 has a tire boss 41 over which the wheel portion of the tire is mounted and which is rotatably inserted over the axle 42. For each tire 40, a fixing hole formed through the tire boss 41 perpendicularly to the axial direction of the axle 42 and a tire fixing hole 420 formed through the axle 42 also perpendicularly to the axial direction of the axle 42 are aligned, and a lock pin 47 is inserted through both through-holes, thereby, fixing each tire 40 to the axle 42. The axle 42 has two tire fixing holes 420 formed through an end portion thereof on each side. When, as shown in FIG. 4, a lock pin 47 is inserted through only the outer one of the two tire fixing holes 420 on each side of the axle 42 without inserting the lock pin 47 through the fixing hole formed through the tire boss 41, the tire 40 is rotatably retained on the axle 42. In this state, the drive force of the electric motor 46 is not conveyed to the tire 40, that is, the electric traveling part 4 is released from the electric drive force, so that the cart 1 can be used as a non-powered hand conveyance cart.

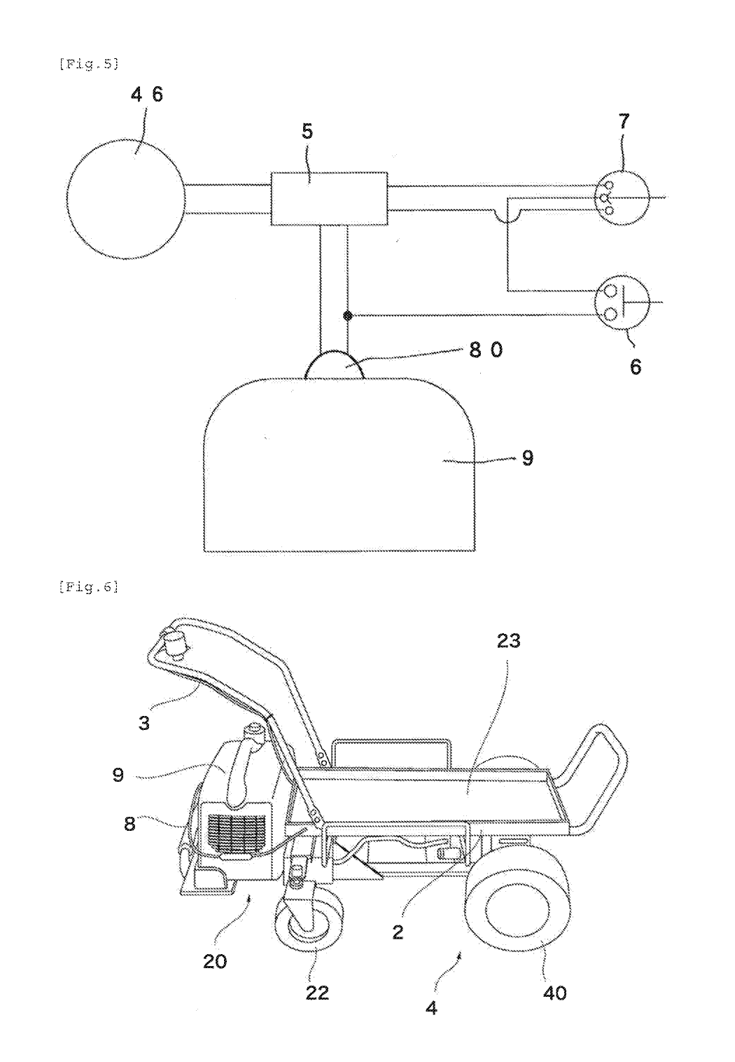

FIG. 5 is an electrical wiring diagram representing an example of the present invention. A relay 5 is connected by wiring with, in addition to a forward/backward changeover switch 7 which operates interlocked with the forward/backward changeover switch lever 31 attached to the handle 3, a travel switch 6 which operates interlocked with the travel switch lever 30 attached to the handle 3 and the electric motor 46. As the power source, the power plug 80 attached to the power cord 8 is plugged into the power outlet of the portable engine generator 9, causing power to be supplied from the portable engine generator 9 to the relay 5.

When the forward/backward changeover switch lever 31 attached to the handle 3 is put in the forward or backward travel position, the forward/backward changeover switch 7 is switched to cause the circuit of the relay 5 to change the rotation direction of the electric motor 46 so as to allow the cart 1 to travel forward or backward. When, after the position of the forward/backward changeover switch lever 31 is changed, the travel switch lever 30 is grasped, the travel switch 6 interlocked with the travel switch lever 30 is switched on, thereby, causing the relay 5 to supply the power from the portable engine generator 9 to the electric motor 46. As a result, the electric motor 46 rotates for a forward or backward travel.

When the walking conveyance cart 1 of the present invention is used to carry a portable engine generator 9, the portable engine generator 9 is placed on the placement part 20 of the cart frame 2 and is fixed there. Subsequently, the power plug 80 attached to the end of the power cord 8 extending from the electric traveling part 4 provided downward of the cart frame 2 is plugged into the outlet of the portable engine generator 9 and the portable engine generator 9 is started.

When removing the portable engine generator 9 from the placement part 20, the portable engine generator 9 is unfixed from the placement part 20. Since the placement part 20 is easily accessibly positioned between the tires 40 on the left and right sides of a forward portion of the cart frame 2 and upward of the caster wheels 22, the portable engine generator 9 can be smoothly placed on and removed from the placement part 20.

When the user grasping the handle 3 puts the forward/backward changeover switch lever 31 into the forward or backward travel position and grasps the travel switch lever 30, the walking conveyance cart 1 travels forward or backward depending on the position of the forward/backward changeover switch lever 31. In this case, the electric motor 46 for driving the tires 40 rotates using the power supplied from the portable engine generator 9. The walking conveyance cart 1 itself does not require any power supply such as batteries, so that it can be provided as a simple-structured, low-priced conveyance cart.

When, on each side of the cart 1, a lock pin 47 is inserted through only the outer tire fixing hole 420 of the axle 42 without inserting the lock pin 47 through the fixing hole formed through the tire boss 41, i.e. the fixing portion of the tire 40, the tire 40 is rotatably retained on the axle 42. In this state, the tire 40 is released from the electric drive force of the electric motor 46, so that the cart 1 can be used as a non-powered hand conveyance cart.

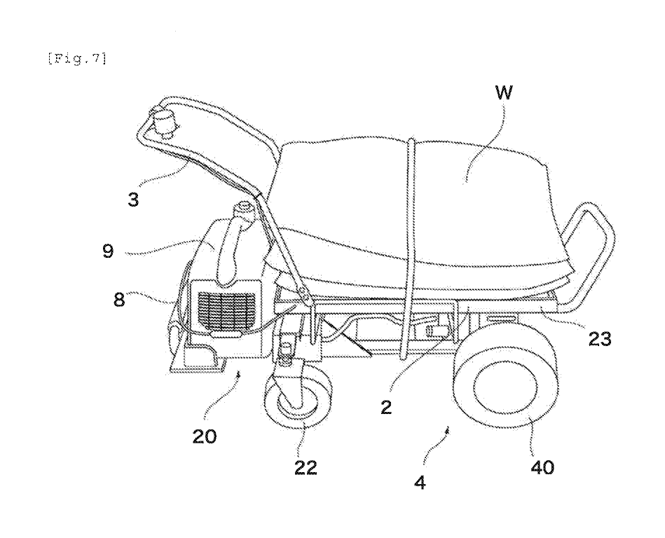

A second embodiment of the present invention will be described below with reference to FIGS. 6 and 7. In the second embodiment, the auxiliary basket 21 of the first embodiment is provided, on the handle 3 side of the cart 1, as a placement part 20 where the portable engine generator 9 is placed.

In the second embodiment, the part corresponding to the placement part 20 of the first embodiment is used as a flat pallet part 23 as shown in FIG. 7. The pallet part 23 is used to carry a load W other than the portable engine generator 9, for example, a fuel container containing fuel for the portable engine generator 9 or various materials.

The placement part 20 of the second embodiment is provided on an open plane over the cart 1.

With the placement part 20 easily accessibly positioned in the second embodiment, too, the portable engine generator 9 can be smoothly placed on and removed from the placement part 20.

The present invention can be applied to a walking conveyance cart provided with an electrically operated traveling part.

1. A walking conveyance cart comprising an electrically driven traveling part,
the walking conveyance cart including a placement part for placing thereon a portable engine generator,
wherein the traveling part can be driven using power outputted from the portable engine generator placed on the placement part as a power source.

2. The walking conveyance cart according to claim 1, wherein the placement part is provided on an open plane over the walking conveyance cart.

3. The walking conveyance cart according to claim 1, wherein the placement part is provided on a cart frame included in the walking conveyance cart.

4. The walking conveyance cart according to claim 1, wherein the placement part for placing thereon a portable engine generator is configured to allow the portable engine generator to be fixed thereto and removed therefrom, and the traveling part is configured to be releasable from electric drive force to make the walking conveyance cart usable as a non-powered hand conveyance cart.

5. The walking conveyance cart according to claim 1, further comprising an auxiliary basket provided adjacent to the placement part.
